(19) United States
(12) Patent Application Publication
(10) Pub. No.: US 2013/0234534 A1
(43) Pub. Date: Sep. 12, 2013

(54) POWER SOCKET WITH WIRELESS COMMUNICATION CAPABILITY, SYSTEM HAVING THE SAME AND METHOD THEREOF

(71) Applicant: PATRICK LIN, NEW TAIPEI CITY (TW)

(72) Inventor: PATRICK LIN, NEW TAIPEI CITY (TW)

(73) Assignee: AZUREWAVE TECHNOLOGIES, INC., NEW TAIPEI CITY (TW)

(21) Appl. No.: 13/417,964

(22) Filed: Mar. 12, 2012

(51) Int. Cl. H02B 1/24

(52) U.S. Cl. 307/112

(57) ABSTRACT

This instant disclosure provides a power socket with wireless communication capability including a case, a power input unit, a power output unit, a switch, and a wireless communication module. The power input unit is used for electrically coupling to a power source. The power output unit is used to output an electrical power of the power source. The switch is electrically coupled between the power input unit and the power output unit for controlling whether the power output unit outputs the electrical power of the power source. The wireless communication module is electrically coupled to the power input unit and the switch for wireless receiving a control signal. The wireless communication module controls the switch according to the control signal. Therefore, the power socket outputs or not outputs the electrical power of the power source to an electrical device according to the control signal.

### BACKGROUND OF THE INVENTION

1. Field of the Invention

The instant disclosure relates to a socket; in particular, to a power socket with wireless communication capability, system having the same and method thereof.

2. Description of Related Art

The power control of the traditional home appliance can be made by manipulating the power switch on the traditional home appliance. However, the traditional home appliance may not have the function of remote-control. When the human operator wants to turn-on or turn-off the power of the traditional home appliance, he or she needs to switch the power manually or remove the power plug of the home appliance from the power socket of the supply mains (e.g. the public utility grid). When the human operator is not near to the home appliance, he or she may hard to switch the power of the home appliance. For example, when the human operator is not at home and finds out he forgot to turn-off the home appliance, he or she may go home and succeed in finding the home appliance for turning-off the home appliance.

Although, some home appliance have the function of wirelessly remote-control. It is not convenient for the human operator to carry all remote controllers for all home appliances. Furthermore, the distance of remote-controlling is usually limited, and the traditional remote controller may not work when the human operator is not at home.

### SUMMARY OF THE INVENTION

The object of the instant disclosure is to provide a power socket with wireless communication capability, system having the same and method thereof. The power socket with wireless communication capability can receive the control signal from the handheld calculating device with wireless communication capability through the wireless router and the network service platform, and the power socket with wireless communication capability can be controlled by the handheld calculating device with wireless communication capability accordingly.

In order to achieve the aforementioned objects, according to an embodiment of the present invention, a power socket with wireless communication capability is offered. The power socket with wireless communication capability comprises a power input unit, a power output unit, a switch, and a wireless communication module. The power input unit is for electrically coupling to a power source. The power output unit is for outputting the electric power of the power source. The switch is electrically coupled between the power input unit and the power output unit for controlling whether the power output unit outputs the electric power of the power source. The wireless communication module is electrically coupled to the power input unit and the switch for wirelessly receiving a control signal. The wireless communication module controls the switch according to the control signal.

In order to achieve the aforementioned objects, according to an embodiment of the present invention, a remote power switching system is offered. The remote power switching system comprises a wireless router and a power socket with wireless communication capability. The wireless router receives a control signal transmitted from a handheld calculating device with wireless communication capability through a network service platform, and the wireless router wirelessly transmits the control signal. The power socket with wireless communication capability comprises a power input unit, a power output unit, a switch, and a wireless communication module. The power input unit is for electrically coupling to a power source. The power output unit is for outputting the electric power of the power source. The switch is electrically coupled to the power input unit and the power output unit for controlling whether the power output unit outputs the electric power of the power source. The wireless communication module is electrically coupled to the power input unit and the switch for receiving the control signal wirelessly transmitted by the wireless router, and the wireless communication module controls the switch according to the control signal.

In order to achieve the aforementioned objects, according to an embodiment of the present invention, a method for controlling a power socket with wireless communication capability is offered. The method is adapted for a remote power switching system. The remote power switching system comprises a wireless router and a power socket with wireless communication capability. The power socket with wireless communication capability is utilized for connecting to a power source. The method comprises a handled calculating device with wireless communication capability transmitting a control signal to the wireless router through a network service platform, the wireless router wirelessly transmitting the control signal to the power socket with wireless communication capability, and the control signal controlling whether the power socket with wireless communication capability outputs the electrical power of the power source.

In summary, the power socket with wireless communication capability, system having the same and method thereof can be used to connect the power socket with wireless communication capability between the power plug of electric device and the power outlet of the public utility grid. The human operator can use a handheld calculating device with wireless communication capability to control the power socket with wireless communication capability for switching the power of the electric device. When any electric device is connected to a power source (e.g. the public utility grid) through the power socket with wireless communication capability, the power of the electric device can be controlled by the handheld calculating device with wireless communication capability. The human operator does not need to modify the electric device for remote-controlling the electric device.

In order to further the understanding regarding the present invention, the following embodiments are provided along with illustrations to facilitate the disclosure of the present invention.

### BRIEF DESCRIPTION OF THE DRAWINGS

FIG. 1A shows a block diagram of a power socket with wireless communication capability according to an embodiment of the instant disclosure;

FIG. 1B shows a schematic diagram of a power socket with wireless communication capability according to an embodiment of the instant disclosure;

FIG. 1C shows a schematic diagram of a power socket with wireless communication capability connecting with an electrical device according to an embodiment of the instant disclosure;

FIG. 2A shows a schematic diagram of a power socket with wireless communication capability according to another embodiment of the instant disclosure;

FIG. 2B shows a schematic diagram of a power socket with wireless communication capability connecting with a electrical device according to another embodiment of the instant disclosure;

FIG. 2C shows a schematic diagram of a power socket with wireless communication capability according to another embodiment of the instant disclosure;

FIG. 3A shows a schematic diagram of a power socket with wireless communication capability according to another embodiment of the instant disclosure;

FIG. 3B shows a schematic diagram of a power socket with wireless communication capability connecting with a electrical device according to another embodiment of the instant disclosure;

FIG. 4 shows a schematic diagram of a remote power switching system according to an embodiment of the instant disclosure; and

FIG. 5 shows a flow chart of a method for controlling a power socket with wireless communication capability according to an embodiment of the instant disclosure.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

[An Embodiment of a Power Socket with Wireless Communication Capability]

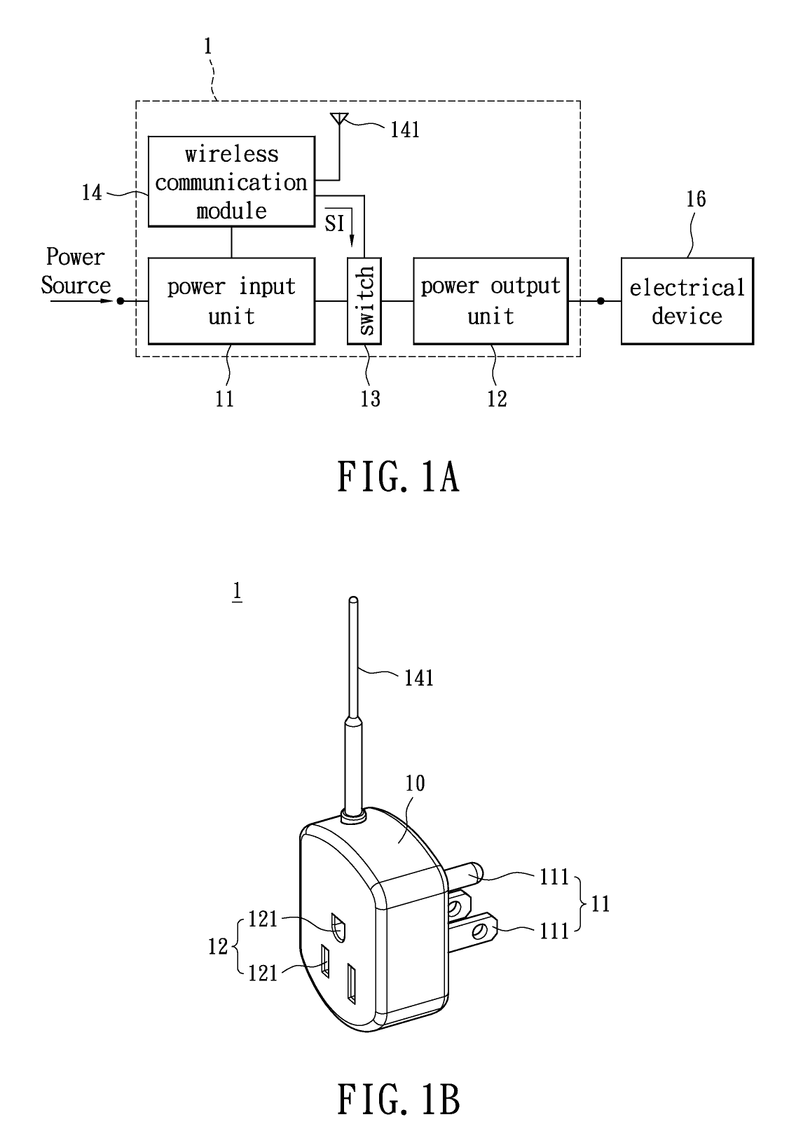

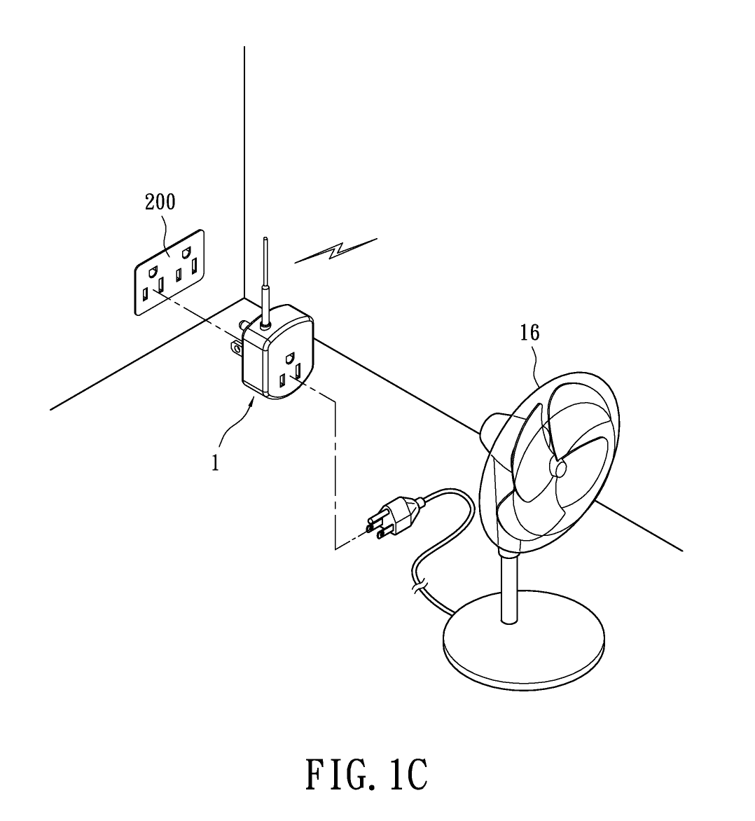

Please refer to FIG. 1A and FIG. 1B, FIG. 1A shows a block diagram of a power socket with wireless communication capability according to an embodiment of the instant disclosure, FIG. 1B shows a schematic diagram of a power socket with wireless communication capability according to an embodiment of the instant disclosure. A power socket with wireless communication capability 1 comprises a casing 10, a power input unit 11, a power output unit 12, a switch 13 and a wireless communication module 14. The wireless communication module 14 has an antenna 141. The power socket with wireless communication capability 1 is used for electrically coupling between a power source and an electrical device 16. In this embodiment, the power source can be a public utility grid, and the power socket with wireless communication capability 1 transmits the electrical power of the public utility grid to the electrical device 16.

The power input unit 11 is disposed on the surface of the casing 10, and the power output unit 12 is disposed on the surface (another side) of the casing 12. The switch 13 is electrically coupled between the power input unit 11 and the power output unit 12. The wireless communication module 14 is electrically coupled to the power input unit 11 and the switch 13. The power output unit 12 is for electrically coupling to the electrical device 16. The antenna 141 of the wireless communication module 14 is disposed on the casing 10.

Please refer to FIG. 1A again. The power input unit 11 is for electrically coupling to a power source, such as a public utility grid. The power output unit 12 is for outputting the electrical power of the power source. The switch 13 is for controlling whether the power output unit 12 outputs the electrical power of the power source. The wireless communication module 14 is electrically coupled to the power input unit 11 and the switch 13, for wirelessly receiving a control signal SI. The wireless communication module 14 transmits the control signal SI to the switch 13. The wireless communication module 14 controls the switch 13 according to the control signal SI. The wireless communication module 14 can be a WiFi module or a Bluetooth module.

Please refer to FIG. 1A and FIG. 1B again. For reducing the volume of the casing 10 and making the power plug of the electrical device 16 be easily connected to the power socket with wireless communication capability 1, the power input unit 11 can be disposed on a first surface of the casing 10, and the power output unit 12 can be disposed on a second surface of the casing 10. In other words, the power input unit 11 and the power output unit 12 can be disposed on different surface of the casing, but the invention is not restricted thereto.

In this embodiment, the power input unit 11 has at least a conductive connector 111, and three conductive connectors 111 are shown in FIG. 1B, but the invention is not restricted thereto. In general, the voltage of the power source may about to 110 volts or 220 volts. A power source with 110 volts provides a signal phase alternating current (50˜60 Hz AC) which needs at least two connecting terminals, and the power source with 10 volts may needs a third connecting terminals for grounding. A power source with 220 volts provides three phase alternating current (AC) which needs three connecting terminals. The conductive connectors 111, shown in FIG. 1B, are for connecting the three terminals of the power source with 110 volts (or 220 volts), and the conductive connectors 111 are protruding from the surface of the casing 10. In other words, the connective connectors 111 can be male-type conductive connectors. In general, the power outlet (connected to the public utility grid) embedded in the wall or the pillar has inserting holes (female-type), thus the power socket with wireless communication capability 1 can be electrically coupled to the public utility grid through the conductive connectors 111 of the power input unit 11. However, the type of the conductive connector 111 of the power input unit 11 is not restricted thereto; the conductive connector 111 can also be a female-type conductive connector, as long as the conductive connector 111 can be connected to the connector of the power source.

Please refer to FIG. 1A and FIG. 1B again. The power output 12 has at least an inserting hole 121 disposed on the surface of the casing. In this embodiment, the power output unit 12 has three inserting holes 121, as shown in FIG. 1B. The power plug of the electrical device 16 can be connected to the inserting holes 121 for making the electrical device 16 receive electrical power of the public utility grid through the power socket with wireless communication capability 1. The electrical device 16 can be home appliance, such as the audio equipment, a desk lamp, or an electric fan.

Please refer to FIG. 1A and FIG. 1B again. The switch 13 is conductive or non-conductive according to the control signal SI. The control signal SI can be a voltage transmitted from the wireless transmission module 14 to the switch 13. For example, when the control signal SI is at a high voltage level (e.g. 12 volts), the switch 13 is conductive. When the control signal SI is at a low voltage level (e.g. 5 volts), the switch 13 is non-conductive. When the switch 13 is conductive, the electric power received by the power input unit 11 can be transmitted to the power output unit 12 through the switch 13. When the switch 13 is non-conductive, the electric power received by the power input unit 11 can not be transmitted to the power output unit 12.

Additionally, the wireless communication module 14 can transmit a status signal, the status signal can indicate whether the power output unit 12 outputs electric power of the power source. For example, when the wireless communication module 14 transmits the control signal SI the switch 13 for making the switch 13 be non-conductive, the wireless communication module 14 can wirelessly transmits the status signal for indicating the power socket with wireless communication capability 1 not outputting electric power of the power source.

Please refer to FIG. 1B again. The antenna 141 is disposed on the surface of the casing 10, but the invention is not restricted thereto. The antenna 141 is for ease of explanation, the antenna 141 can be an internal antenna installed in the casing 10. An artisan of ordinary skill in the art will appreciate the implementation manner of the antenna 141, thus there is no need to go into details.

Please refer to FIG. 1A, FIG. 1B, and FIG. 1C, FIG. 1C shows a schematic diagram of a power socket with wireless communication capability connecting with an electrical device according to an embodiment of the instant disclosure. The power socket with wireless communication capability 1 is connected to the power outlet 200 through the conductive connectors 111 of the power input unit 11. The power plug of the electric device 16 can be connected to the inserting holes 121 of the power output unit 12 for making the electric device 16 receive electric power of the public utility grid through the power socket with wireless communication capability 1. The power socket with wireless communication capability 1 can also be designed to be easy to carry, thus the convenience of controlling the electric device 16 can be increased.

[Another Embodiment of the Power Socket with Wireless Communication Capability]

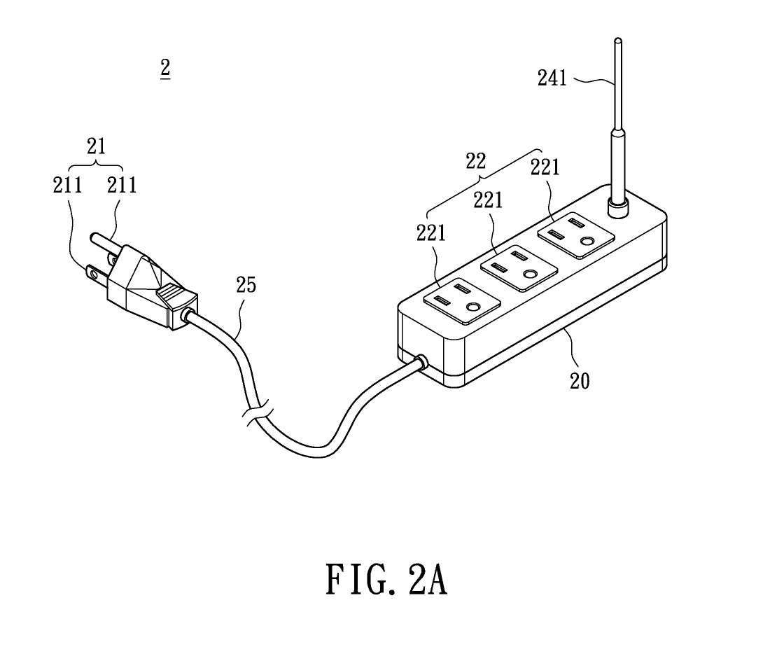

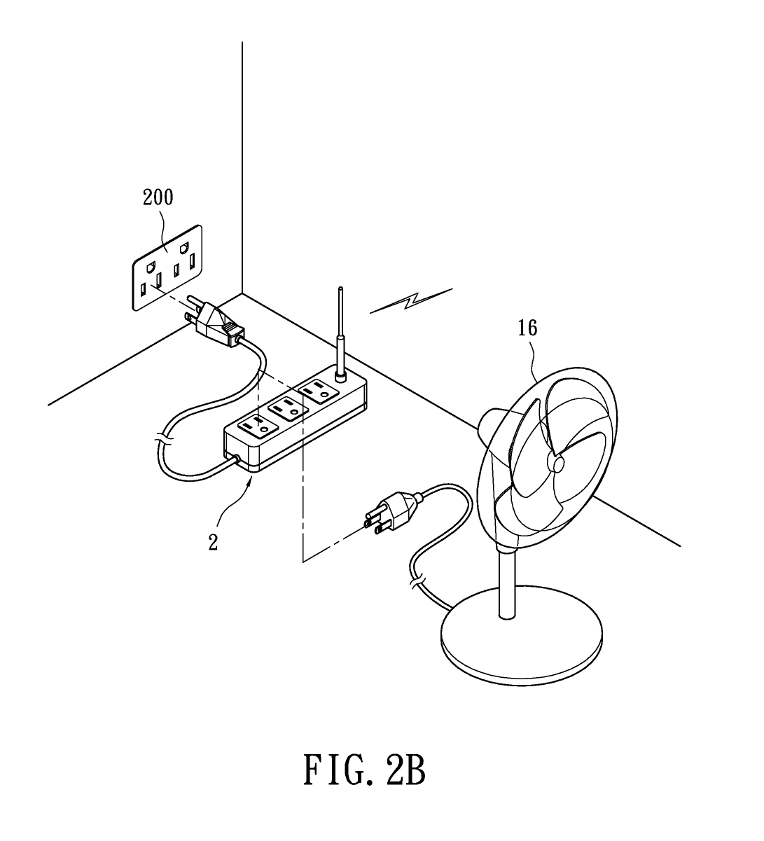

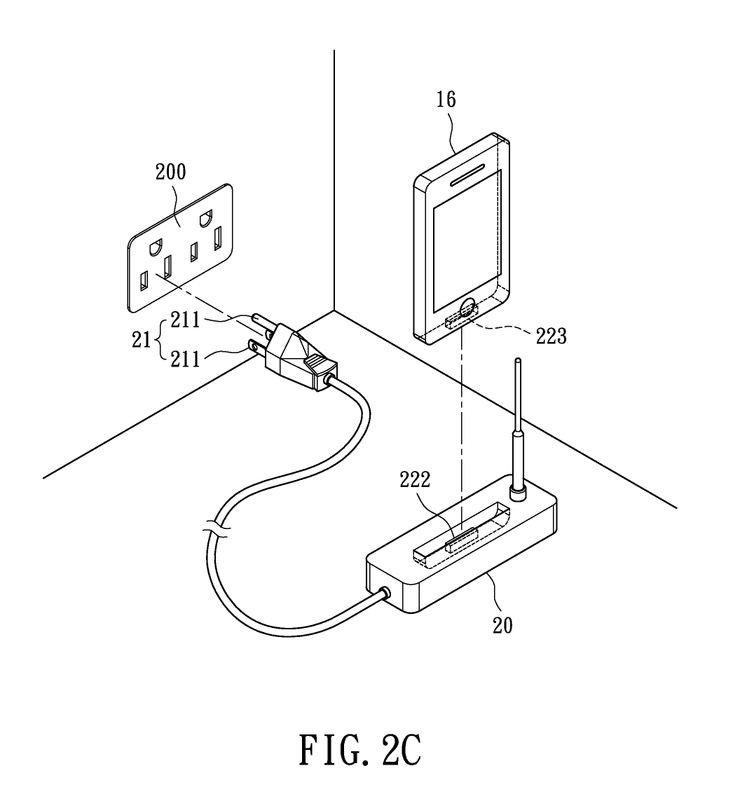

Please refer to FIG. 2A, FIG. 2A shows a schematic diagram of a power socket with wireless communication capability according to another embodiment of the instant disclosure. The power socket with wireless communication capability 2 comprises a casing 20, a power input unit 21, an extension cord 25, three power output units 22, a switch (not shown in the figure), and a wireless communication module (not shown in the figure). The wireless communication module has an antenna 241. The power input unit 21 has at least a conductive connector 211. Each of the power output unit 22 has at least an inserting hole 221. As shown in FIG. 2A, the power socket with wireless communication capability 2 has three power output units 22, and each of the power output unit 22 has three inserting holes 221, but the invention is not restricted thereto.

The block diagram of the power socket with wireless communication capability 2 is the same as to the block diagram of the power socket with wireless communication capability 1 in the previous embodiment (shown in FIG. 1A), thus the redundant information is not repeated. The power socket with wireless communication capability 2 is significantly identical to the power socket with wireless communication capability 1 of the previous embodiment except for differences specified in the follows. The power socket with wireless communication capability 2 further comprises the extension cord 25. The extension cord 25 is electrically coupled to the switch 13 and the wireless communication module 14, and the extension cord 25 extends from the surface of the casing 20. The power input unit 21 has at least a conductive connector 211 electrically coupled to the extension cord 25 for making the power input unit 21 be electrically coupled to the power source (e.g. public utility grid) through the conductive connector 211.

Please refer to FIG. 1B, FIG. 2A, and FIG. 2B, FIG. 2B shows a schematic diagram of a power socket with wireless communication capability connecting with a electrical device according to another embodiment of the instant disclosure. The power socket with wireless communication capability 2 is utilized for electrically coupling between the power source and the electric device 16. Comparing to the power socket with wireless communication capability 1 shown in FIG. 1B, the power socket with wireless communication capability 2 of this embodiment not only can have multiple power output units 22 for connecting multiple electric devices 16 but also has the extension cord 25. The extension cord 25 is for making the power socket with wireless communication capability 2 have the capability of being moved away from the power outlet 200.

Please refer to FIG. 2A and FIG. 2C, FIG. 2C shows a schematic diagram of a power socket with wireless communication capability according to another embodiment of the instant disclosure. It is worth mentioning that the inserting holes 221 of the power output unit 22 shown in FIG. 2A can be changed to the male-type conductive connector. But the instant disclosure is not so restricted, as long as the power output unit 22 can be connected to the power connector of the electric device 16. For example, the power output unit 22 of the power socket with wireless communication capability 2 can be the conductive connector 222 in male-type shown in FIG. 2C, and the conductive connector 222 protrudes from the surface of the casing 20. When the electric device 16 is a handset, the power connector for charging the electric device 16 can be a conductive connector 223 in female-type. In summary, the power output unit 22 of the power socket with wireless communication capability 2 can be designed corresponding to the power connector of the electric device 16.

[Another Embodiment of the Power Socket with Wireless Communication Capability]

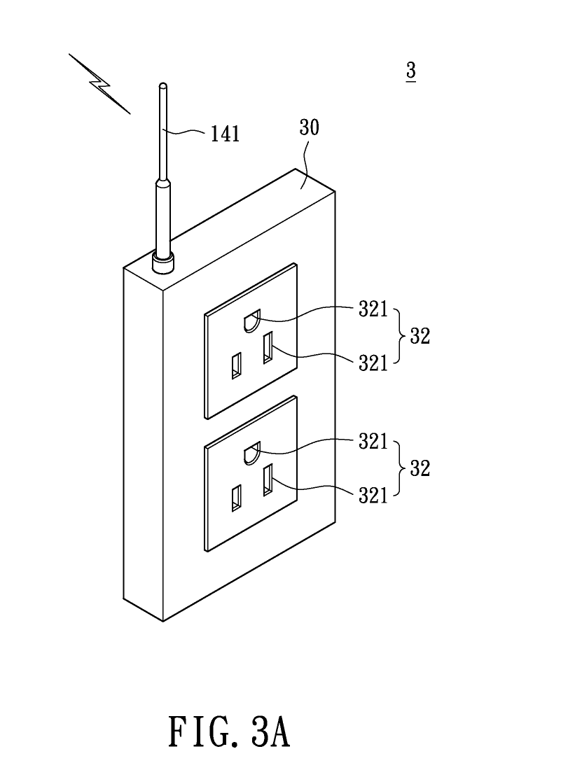

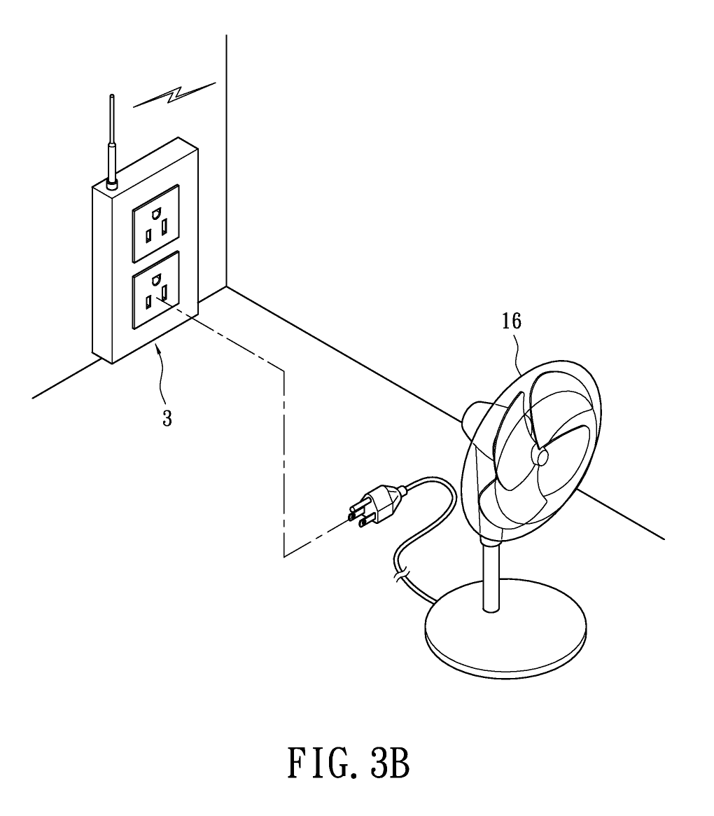

Please refer to FIG. 3A, FIG. 3A shows a schematic diagram of a power socket with wireless communication capability according to another embodiment of the instant disclosure. A power socket with wireless communication capability 3 is embedded in the wall or pillar, and the power socket with wireless communication capability 3 can replace the traditional power outlet on the wall. The power socket with wireless communication capability 3 comprises a casing 30, a power input unit (not shown in the figure), a power output unit 32, a switch (not shown in the figure), and a wireless communication module (not shown in the figure). The wireless communication module has an antenna 141. At least a power output unit 32 has at least an inserting hole 321, and the inserting hole is disposed on the surface of the casing 30. In FIG. 3A, the power socket with wireless communication capability 3 has two power output units 32, and each of the power output unit 32 has three inserting holes 321, but the instant disclosure is not restricted thereto.

The block diagram of the power socket with wireless communication capability 3 is the same as to the block diagram of the power socket with wireless communication capability 1 shown in FIG. 1A, thus the redundant information is not repeated. The power socket with wireless communication capability 3 is significantly identical to the power socket with wireless communication capability 3 except for differences specified in the follows. The power input unit of the power socket with wireless communication capability 3 is disposed in the casing 30, thus the power input unit is directly connected to the power source. For example, the conductive connector of the power input unit is directly connected to the indoor wiring of the public utility grid. An artisan of ordinary skill in the art will appreciate the implementation manner of the power input unit, thus there is no need to go into details.

Please refer to FIG. 1B, FIG. 3A, and FIG. 3B, FIG. 3B shows a schematic diagram of a power socket with wireless communication capability connecting with a electrical device according to another embodiment of the instant disclosure. The power socket with wireless communication capability 3 is utilized to be connected between the power source and the electric device 16. Comparing to the power socket with wireless communication capability 1 shown in FIG. 1B, the power socket with wireless communication capability 3 of this embodiment is embedded in the wall or the pillar, thus the power socket with wireless communication capability 3 can replace the traditional power outlet.

[An Embodiment of the Remote Power Switching System]

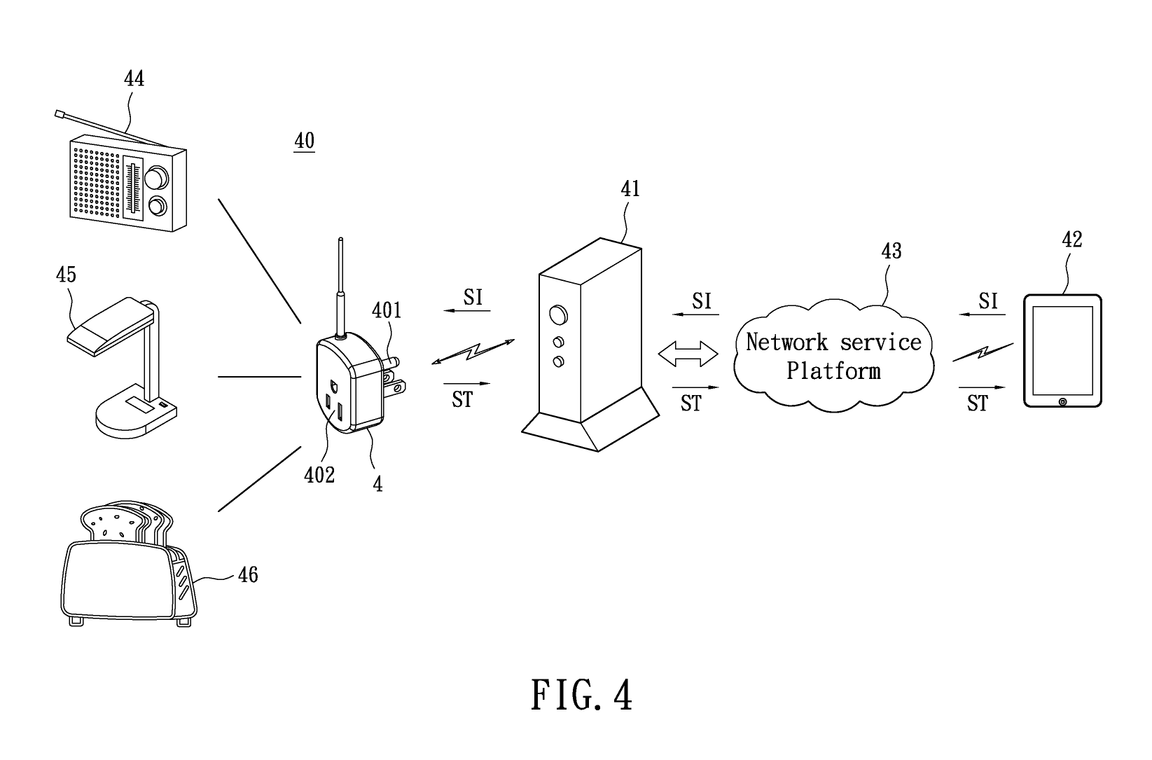

Please refer to FIG. 1A, FIG. 1B, and FIG. 4, FIG. 4 shows a schematic diagram of a remote power switching system according to an embodiment of the instant disclosure. A remote power switching system 40 comprises a power socket with wireless communication capability 4, a wireless router 41 and a handled calculating device with wireless communication capability 42. The power socket with wireless communication capability 4 is the same as to the power socket with wireless communication capability 1 shown in FIG. 1B, and the power socket with wireless communication capability 4 comprises a power input unit 401, a power output 402, a switch (not shown in the figure), and a wireless communication module (not shown in the figure).

The wireless router 41 transmits the control signal SI to the power socket with wireless communication capability 4. The handled calculating device with wireless communication capability 42 is wirelessly linked to the network service platform 43 and transmits the control signal SI to the wireless router 41 through the network service platform 43. The power socket with wireless communication capability 4 can be connected to the electric device 44, 45, or 46 through the power output unit 42.

The network service platform 43 can be a server or a virtual server with cloud computing capability. The handled calculating device with wireless communication capability 42 can be a smart phone or a tablet PC. The handled calculating device with wireless communication capability 42 can be installed with a application program, thus the human operator can operate the mentioned application program to make the handled calculating device with wireless communication capability 42 be linked to the power socket with wireless communication capability 4 through the network service platform 43 and the wireless router 41. For example, the handled calculating device with wireless communication capability 42 links to the power socket with wireless communication capability 4 according to the Media Access Control Address (MAC) of the power socket with wireless communication capability 4 provided by the wireless router 41 and the network service platform 43.

The power socket with wireless communication capability 4 is the same as to the power socket with wireless communication capability 1 shown in FIG. 1A and FIG. 1B. The power input unit 401 is for connecting to the power source, and the power output unit 402 is for outputting the electric power of the power source. The power input unit 401 is the power input unit 11 shown in FIG. 1A, and the power output unit 402 is the power output unit 12. The switch and the wireless communication module of the power socket with wireless communication capability 4 are the switch 13 and the wireless communication module 14 shown in FIG. 1A respectively. In other words, the mentioned switch is electrically coupled between the power input unit 401 and the power output unit 402 for controlling whether the power output unit 402 outputs the electric power of the power source. The mentioned wireless communication module is electrically coupled to the power input unit 401 and the mentioned switch for wirelessly receiving the control signal SI. The wireless communication module controls the mentioned switch according to the control signal SI. For example, the control signal SI can be included in the data packets transmitted to the power socket with wireless communication capability 4, and interpretation of the control signal SI can be made by the wireless communication module.

Additionally, the power socket with wireless communication capability 4 can transmits status signal ST for indicating whether the power output unit 402 outputs the electric power of the power source. For example, when the wireless communication module of the power socket with wireless communication capability 4 transmits the control signal SI to the switch for making the switch be non-conductive, the wireless communication module of the power socket with wireless communication capability 4 can wirelessly transmit the status signal ST for indicating the power socket with wireless communication capability 4 does not output electric power of the power source. For example, the power socket with wireless communication capability 4 can transmit status signal ST including the MAC address of the handheld calculating device with wireless communication capability 42 to the handheld calculating device with wireless communication capability 42 according to the communication protocol for linking the handheld calculating device with wireless communication capability 42 and the power socket with wireless communication capability 4.

However, the instant disclosure is not so restricted. The status signal ST can be included in the data packets transmitted to the handheld calculating device with wireless communication capability 42. The manner of addressing the data packets to the handheld calculating device with wireless communication capability 42 can be, for example, using the Web address or the address of the Internet Protocol (IP).

More specifically, the wireless communication module of the power socket with wireless communication capability 4 transmits the status signal ST to the wireless router 41, and the status signal ST is for indicating whether the power socket with wireless communication capability 4 outputs the electric power of the power source. Then the status signal ST is transmitted from the wireless router 41 to the handheld calculating device with wireless communication capability 42 through the network service platform 43. Accordingly, the human operator of the handheld calculating device with wireless communication capability 42 can be informed whether the power socket with wireless communication capability 4 outputs electric power of the power source, and the human operator can know whether the power of the electric device 44, 45, or 46 is turned-on or turned-off.

[An Embodiment of a Method for Controlling a Power Socket with Wireless Communication Capability]

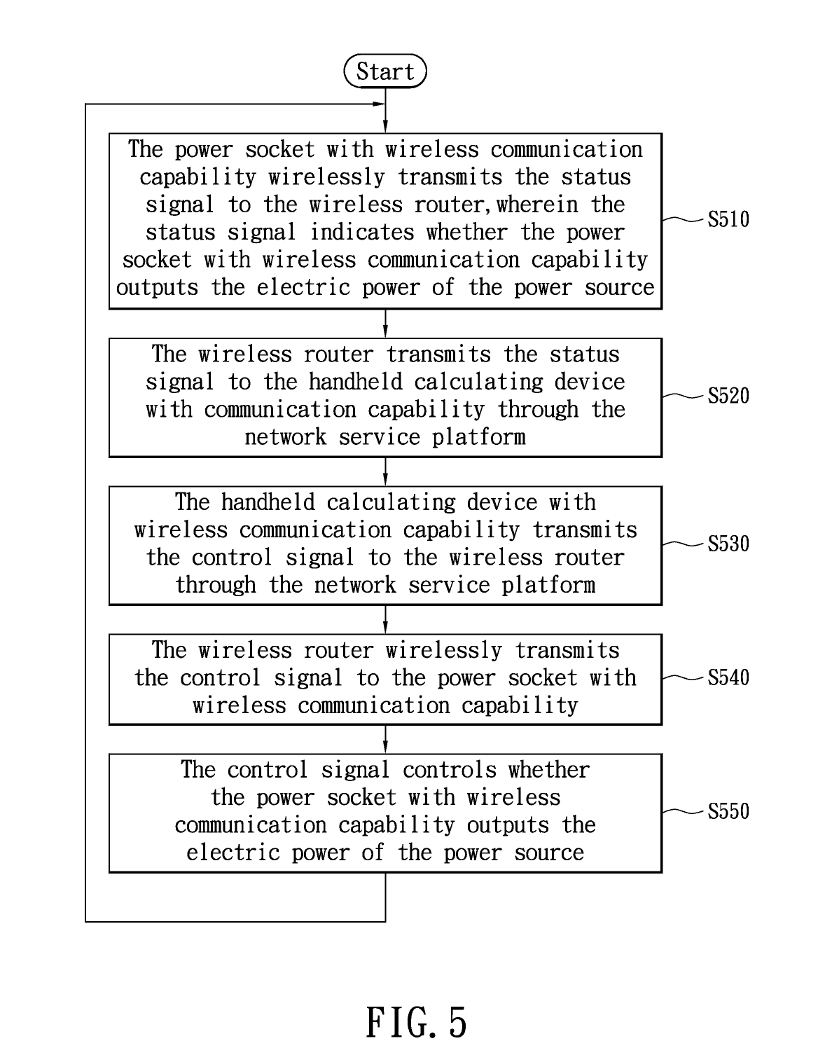

Please refer to FIG. 4 and FIG. 5, FIG. 5 shows a flow chart of a method for controlling a power socket with wireless communication capability according to an embodiment of the instant disclosure. The method is adapted for the remote power switching system 40 comprising the handheld calculating device with wireless communication capability 42, the wireless router 41 and the power socket with wireless communication capability 4. The method comprises following steps.

Firstly, in step S510, the power socket with wireless communication capability 4 wirelessly transmits the status signal ST to the wireless router, wherein the status signal ST indicates whether the power socket with wireless communication capability 4 outputs the electric power of the power source. Then, in step S520, the wireless router 41 transmits the status signal ST to the handheld calculating device with communication capability 42 through the network service platform 43. The step S510 and the step 520 can make the power socket with wireless communication capability 4 transmit the status signal ST to the handheld calculating device with communication capability 42. The handheld calculating device with communication capability 42 can be installed with an application program for linking with the power socket with wireless communication capability 4 by using the network service platform 43 and the wireless router 41. The mentioned application program can generate a function icon displayed on the screen of the hand held calculating device with communication capability 42 for representing the status signal ST. Thus, the human operator can know whether the power socket with wireless communication capability 4 outputs the electric power of the power source by seeing the mentioned function icon. It is worth mentioning that the step S510 and the step S520 can be executed after the following steps S530, S540, and S550 or before the steps S530, S540, and S550.

In step S530, the handheld calculating device with wireless communication capability 42 transmits the control signal SI to the wireless router 41 through the network service platform 43. More specifically, the human operator can check up whether the power socket with wireless communication capability 4 outputs the electric power of the power source. The human operator can manipulate the input interface (e.g. buttons or the touch screen) of the handheld calculating device with wireless communication capability 42 to make the handheld calculating device with wireless communication capability 42 transmit the control signal SI to the wireless router 41 through the network service platform 43.

In step S540, the wireless router 41 wirelessly transmits the control signal SI to the power socket with wireless communication capability 4. In step S550, the control signal SI controls whether the power socket with wireless communication capability 4 outputs the electric power of the power source. According to the steps S520˜S550, the handheld calculating device with wireless communication capability 42 can remote-control the power socket with wireless communication capability 4 to output electric power of the power source or not.

According to the aforementioned embodiments, the power socket with wireless communication capability, system having the same and method thereof can be used to connect the power socket with wireless communication capability between the power plug of electric device and the power outlet of the public utility grid. The human operator can use a handheld calculating device with wireless communication capability to control the power socket with wireless communication capability for switching the power of the electric device. When any electric device is connected to a power source (e.g. the public utility grid) through the power socket with wireless communication capability, the power of the electric device can be controlled by the handheld calculating device with wireless communication capability. The human operator does not need to modify the electric device for remote-controlling the electric device. Additionally, the power socket with wireless communication capability can replace the traditional power socket. The power socket can be designed to be easy to carry, or the power socket can have an extension cord for letting the human operator make the power setting of any electric device to be remotely controllable. Thus, the convenience of using the electric devices is significantly improved.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A power socket with wireless communication capability, comprising:
a power input unit, for electrically coupling to a power source;
a power output unit, for outputting the electrical power of the power source;
a switch, electrically coupled between the power input unit and the power output unit, for controlling whether the power output unit outputs the electrical power of the power source; and
a wireless communication module, electrically coupled to the power input unit and the switch, for wirelessly receiving a control signal, controlling the switch according to the control signal.

2. The power socket with wireless communication capability according to claim 1, wherein the wireless communication module wirelessly transmits a status signal for indicating whether the power output unit outputs the electrical power of the power source.

3. The power socket with wireless communication capability according to claim 1, further comprising:
a casing, at least a conductive connector of the power input unit protruding from the surface of the casing;
wherein, the power output unit has at least an inserting hole, the inserting hole is disposed on the surface of the casing.

4. The power socket with wireless communication capability according to claim 1, further comprising:
a casing, at least an inserting hole of the power output unit is disposed on the surface of the casing.

5. The power socket with wireless communication capability according to claim 1, further comprising:
a casing, at least a conductive connector of the power output unit protruding from the surface of the casing.

6. The power socket with wireless communication capability according to claim 1, wherein the power input unit comprises:
an extension cord, electrically coupled to the switch and the wireless communication module; and
at least a conductive connector, electrically coupled to the extension cords, for letting the power input unit connect to the power source through the conductive connector.

7. The power socket with wireless communication capability according to claim 1, wherein the wireless communication module is a WiFi module or a Bluetooth module.

8. A remote power switching system, comprising:
a wireless router, receiving a control signal transmitted from a handled calculating device with wireless communication capability through a network service platform, and wirelessly transmitting the control signal; and
a power socket with wireless communication capability, comprising:
a power input unit, for electrically coupling to a power source;
a power output unit, for outputting the electrical power of the power source;
a switch, electrically coupled between the power input unit and the power output unit, for controlling whether the power output unit outputs the electrical power of the power source; and
a wireless communication module, electrically coupled to the power input unit and the switch, for wirelessly receiving the control signal transmitted from the wireless router, the wireless communication module controls the switch according to the control signal.

9. The remote power switching system according to claim 8, wherein the wireless communication module of the power socket with wireless communication capability wirelessly transmits a status signal to the wireless router, the status signal is for indicating whether the power output unit outputs the electrical power of the power source, the status is transmitted from the wireless router to the handled calculating device with wireless communication capability through the network service platform.

10. The remote power switching system according to claim 8, wherein the handled calculating device with wireless communication capability is a smart phone or a tablet PC.

11. The remote power switching system according to claim 8, wherein the network service platform is a server or a virtual server with cloud computing capability.

12. A method for controlling a power socket with wireless communication capability, adapted for a remote power switching system, the remote power switching system comprising a wireless router and the power socket with wireless communication capability, the power socket with wireless communication capability being electrically coupled to a power source, the method comprising:
a handled calculating device with wireless communication capability transmitting a control signal to the wireless router through a network service platform;
the wireless router wirelessly transmitting the control signal to the power socket with wireless communication capability; and
the control signal controlling whether the power socket with wireless communication capability outputs the electrical power of the power source.

13. The method according to claim 12, further comprising:
the power socket with wireless communication capability wirelessly transmitting a status signal to the wireless router, wherein the status signal indicates whether the power socket with wireless communication capability outputs the electrical power of the power source; and
the wireless router transmitting the status signal to the handled calculating device with wireless communication capability through the network service platform.
